(19) United States
(12) Patent Application Publication
(10) Pub. No.: US 2012/0092363 A1
(43) Pub. Date: Apr. 19, 2012

(54) APPARATUS EQUIPPED WITH FLEXIBLE DISPLAY AND DISPLAYING METHOD THEREOF

(75) Inventors: Jae Min KIM, Incheon (KR); Jun Hyuk WON, Seoul (KR); Won Gyu CHOI, Seoul (KR); Sung Hwan PARK, Goyang-si (KR); Hyung Geun OH, Seoul (KR); Hyun Woo YOU, Seoul (KR); Eui Seok HAN, Seoul (KR)

(73) Assignee: PANTECH CO., LTD., Seoul (US)

(21) Appl. No.: 13/225,108

(22) Filed: Sep. 2, 2011

(30) Foreign Application Priority Data
Oct. 13, 2010 (KR) 10-2010-0100044

(51) Int. Cl. G06T 5/00

(52) U.S. Cl. 345/618

(57) ABSTRACT

An apparatus includes a flexible display to display an image; a bending measurement unit to measure a bending value of a portion of the flexible display; and a display control unit to correct an image based on the bending value and to control the flexible display to display the corrected image. In a method for displaying a corrected image, a bending value of a portion of a flexible display is measured, a bent shape of the flexible display is estimated using the bending value, an image is corrected based on the bent shape such that the image is viewed as a planar image of a virtual planar display arranged perpendicular to a viewing direction, and the corrected image is displayed.

### CROSS-REFERENCE TO RELATED APPLICATION

This application claims priority from and the benefit of Korean Patent Application No. 10-2010-0100044, filed on Oct. 13, 2010, which is incorporated by reference for all purposes as if fully set forth herein.

### BACKGROUND

1. Field

The following disclosure relates to an apparatus equipped with a flexible display and a method for displaying a corrected image for a user to view a planar image regardless of a curved state of the flexible display.

2. Discussion of the Background

Recently, display fields for processing and displaying a large amount of information have developed in various ways. Accordingly, various types of display devices have emerged.

Examples of the display devices include a liquid crystal display (LCD) device, a plasma display panel (PDP) device, a field emission display (FED) device, an electroluminescence display (ELD) device, and the like. These display devices have thin, lightweight, and low power consumption characteristics. Since these types of display devices use a glass substrate to tolerate high-temperature heat generated in a manufacturing process, various limitations exist in providing lightweight, thin, and flexible characteristics to the above types of display devices. A flexible display device may be an alternative to satisfy users without those limitations. The flexible display device may be manufactured using a flexible material such as plastic rather than the conventional glass substrate having negligible flexibility, so that the display performance of the flexible display device may be maintained even when bent like paper. Since the flexible display device may be undamaged even when folded or rolled like paper, the flexible display device may be carried in a folded state or a rolled state.

However, the flexible display device may provide a distorted image due to its flexible characteristics.

### SUMMARY

Exemplary embodiments of the present invention provide an apparatus equipped with a flexible display and a displaying method thereof.

Additional features of the invention will be set forth in the description which follows, and in part will be apparent from the description, or may be learned by practice of the invention.

An exemplary embodiment of the present invention discloses an apparatus including a flexible display to display an image; a shape estimation unit to estimate a bent shape of the flexible display; and a display control unit to correct the image based on the bent shape and to control the flexible display to display the corrected image.

An exemplary embodiment of the present invention discloses a method for displaying a corrected image including measuring a bending value of a portion of a flexible display; estimating a bent shape of the flexible display using the bending value; correcting an image based on the bent shape to be viewed as a planar image of a virtual planar display arranged perpendicular to a viewing direction; and displaying a corrected image on the flexible display.

An exemplary embodiment of the present invention discloses an apparatus, including a flexible display; a position measurement unit to measure a viewing direction of a viewer; a shape estimation unit to estimate a bent shape of the flexible display; and a display control unit to correct an image based on the bent shape and to control the flexible display to display a corrected image, the display control unit determines a virtual planar display based on the viewing direction of the viewer and the bent shape of the flexible display, determines a projection view of the image of the flexible display projected to the virtual planar display, corrects the image as according to the projection view, and controls the flexible display to display the corrected image.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a diagram illustrating examples of bent flexible displays and a corrected display image of a virtual planar display according to an exemplary embodiment of the present invention.

FIG. 1B is a diagram illustrating a bent flexible display and a projection view of the bent flexible display on a virtual planar display according to an exemplary embodiment of the present invention.

FIG. 1C is a diagram illustrating a bent flexible display and a projection view of the bent flexible display on a virtual planar display according to an exemplary embodiment of the present invention.

FIG. 2 is a block diagram illustrating an apparatus equipped with a flexible display according to an exemplary embodiment of the present invention.

FIG. 3 is a diagram illustrating a combination of a flexible display, a bending measurement unit, and a fixing panel according to an exemplary embodiment of the present invention.

FIG. 4 is a sectional diagram illustrating the combination of a flexible display, a bending measurement unit, and a fixing panel according to an exemplary embodiment of the present invention.

FIG. 5 is a diagram illustrating the arrangement of sensors included in the bending measurement unit when a flexible display is bent according to an exemplary embodiment of the present invention.

FIG. 6 is a diagram illustrating an estimated bent shape according to an exemplary embodiment of the present invention.

FIG. 7 is a diagram illustrating correcting a distorted image into a planar image when a flexible display is bent according to an exemplary embodiment of the present invention.

FIG. 8 is a diagram illustrating the bending degree of a flexible display using shading according to an exemplary embodiment of the present invention.

FIG. 9 is a diagram illustrating a correcting method when a flexible display is bent according to an exemplary embodiment of the present invention.

FIG. 10 is a flowchart illustrating a method for displaying a corrected image using an apparatus equipped with a flexible display according to an exemplary embodiment of the present invention.

FIG. 11 is a flowchart illustrating a method for displaying a corrected image using an apparatus equipped with a flexible display according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure is thorough and complete, and will fully convey the scope of the present disclosure to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention provide an apparatus equipped with a flexible display and a displaying method thereof, in which a distortion due to bending is corrected by measuring the degree of bending of the flexible display, so that the user may view a planar image.

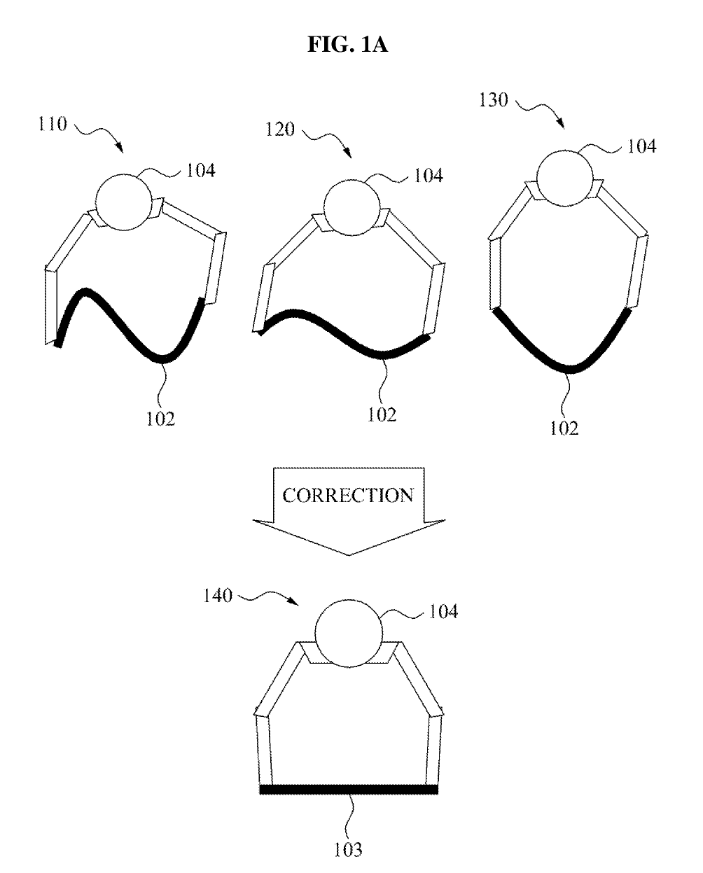

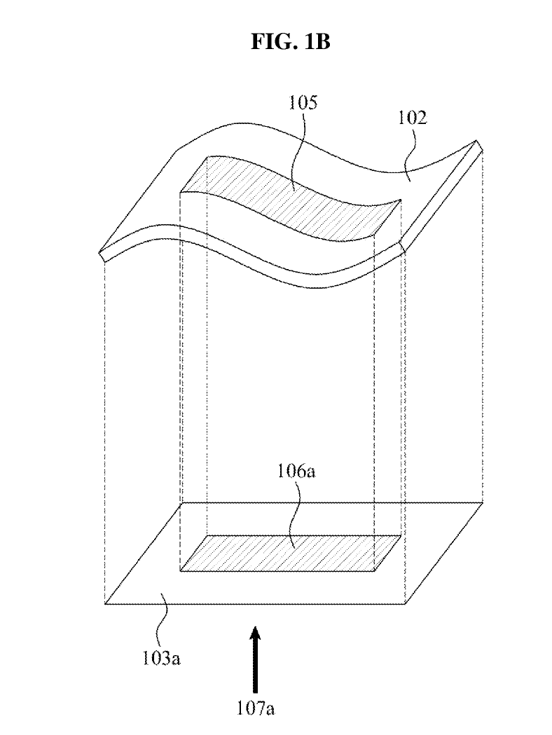

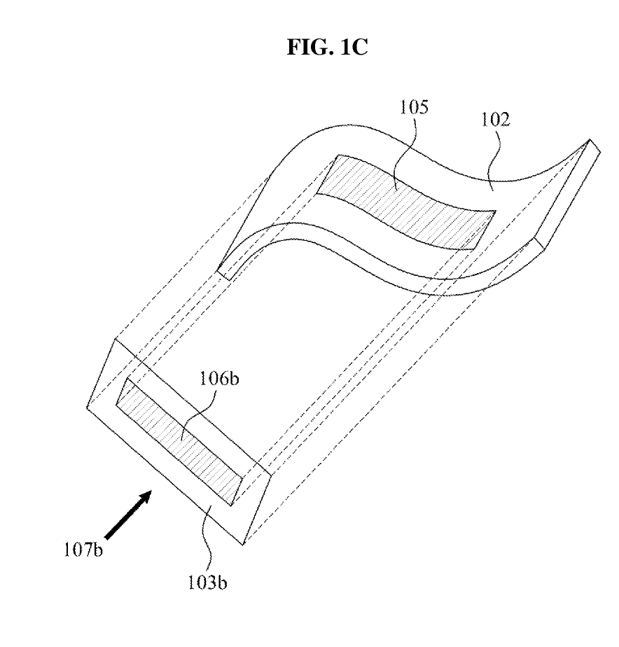

FIG. 1A is a diagram illustrating examples of bent flexible displays and a corrected display image of a virtual planar display according to an exemplary embodiment of the present invention.

Referring to FIG. 1A, the first example 110, the second example 120, and the third example 130 show cases where a flexible display 102 is bent by a viewer 104 (of which an overhead view of the viewer's arm and head is shown). Without a correction of the displayed image in the above three examples 110, 120, and 130, the viewer 104 would view a distorted image from the bent flexible display 102. Hereinafter, distorted image may mean a non-planar image displayed on a bent flexible display. The distorted image may be viewed differently according to different viewing positions of a viewer.

In these examples, image distortions that may occur in the first, second, and third examples 110, 120, and 130 are corrected so that the flexible display 102 is in a virtual plane state as shown in a fourth example 140. The images displayed by the bent flexible display 102 in the first, second, and third examples 110, 120, and 130 may be corrected to display an image that appears to the viewer to be identical to an image displayed by a virtual planar display 103 in example 140. Thus, the viewer may see an undistorted image regardless of curved state of the flexible display 102.

FIG. 1B is a diagram illustrating a bent flexible display and a projection view of the bent flexible display on a virtual planar display according to an exemplary embodiment of the present invention.

Referring to FIG. 1B, the flexible display 102 is in a bent state and displays a distorted image 105 through the bent flexible display 102. If the viewing direction of a viewer is determined as a viewing direction (“determined direction”) 107a, a virtual planar display 103a may be determined as a projection view of the bent flexible display 102 on a plane arranged perpendicular to the determined direction 107a. The distorted image 105 may be viewed as a planar image 106a that is a projection view of the distorted image 105. Thus, the bent flexible display 102 displays a corrected image that a viewer may view in the determined direction 107a as if it were emitted from the virtual planar display 103a.

FIG. 1C is a diagram illustrating a bent flexible display and a projection view of the bent flexible display on a virtual planar display according to an exemplary embodiment of the present invention.

Referring to FIG. 1C, the flexible display 102 is in a bent state and displays a distorted image 105 through the bent flexible display 102. If viewing direction of a viewer is determined as a determined direction 107b, which is different than determined direction 107a, a virtual planar display 103b may be determined as a projection view of the bent flexible display 102 based on the determined direction 107b. The virtual planar display 103b is perpendicular to the determined direction 107b and the distorted image 105 may be corrected as a planar image 106b that is a projection view of the distorted image 105. Thus, the bent flexible display 102 displays a corrected image that a viewer may view in the determined direction 107b as if it were emitted from the virtual planar display 103b.

Thus, a flexible display in a bent state may have a virtual planar display and corresponding projection view that correspond to a determined direction of a viewer. Accordingly, the determined direction may be determined by capturing the position of the viewer of the flexible display 102. Alternatively, the determined direction may be determined by obtaining a direction that maximizes the area of the virtual planar display. For example, the determined direction 107a may be determined as a determined direction because the virtual planar display 103a is the largest plane among the virtual planar displays of the bent flexible display 102. Alternatively, the determined direction may be set to be perpendicular to a plane defined by three or more points of the flexible display 102.

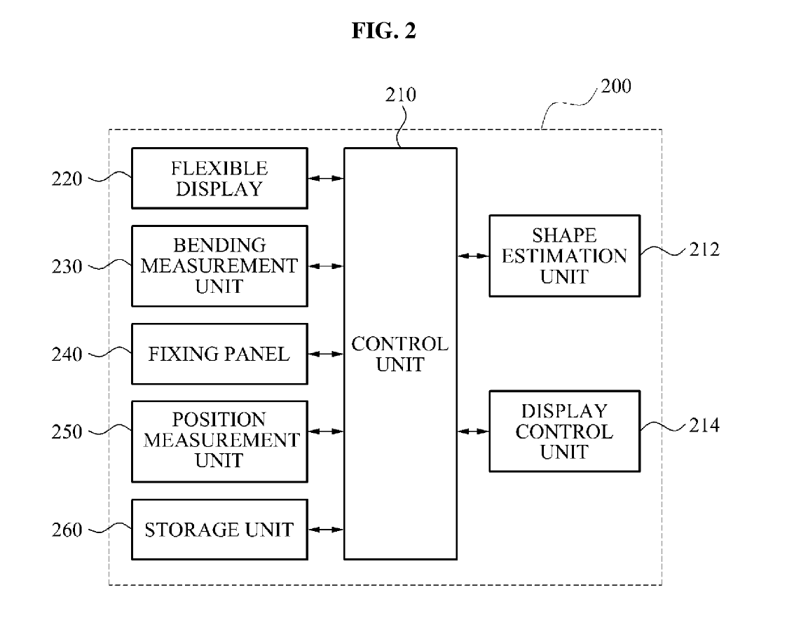

FIG. 2 is a block diagram illustrating an apparatus equipped with a flexible display according to an exemplary embodiment of the present invention.

As shown in FIG. 2, the apparatus 200 may include a control unit 210, a shape estimation unit 212, a display control unit 214, a flexible display 220, a bending measurement unit 230, a fixing panel 240, a position measurement unit 250, and a storage unit 260.

The flexible display 220 may be made of a flexible material, for example a plastic-based material. The flexible display 220 is a display of which display performance may be provided even when it is bent like a paper. The flexible display 220 displays various images such as state information (or an indicator), predetermined numbers and characters, moving pictures, and still pictures, which are generated during the operation of the apparatus 200. Further, the flexible display 220 may display a corrected image so that an image is displayed and viewed as a planar image by a viewer when the flexible display 220 is bent or curved. The display control unit 214 controls the flexible display 220 to display the corrected image.

The bending measurement unit 230 includes at least one sensor that measures a bending value of the flexible display 220. The bending value indicates a bending angle or a degree of bending at one or more positions of the flexible display 220. The bending measurement unit 230 may be attached and fixed to the back of the flexible display 220. In this instance, the sensors may be arranged at predetermined intervals in horizontal and vertical directions of the flexible display 220 so as to measure the bending shape of the flexible display 220. A sensor applicable to the bending measurement unit 230 may be a load cell that is an element for changing a physical force into an electrical signal or a bend sensor having a property whereby resistance increases according to a bending angle.

The fixing panel 240 allows the bending measurement unit 230 to be attached and fixed to the back of the flexible display 220. The fixing panel 240 may be used to fix the bending measurement unit 230 to the back of the flexible display 220.

The functions performed by the units described above and below for the apparatus 200 are not limited as such, and may be performed in full or in part by one or more other units, including those described above, of the apparatus 200. For example, certain computational-based functions of the shape estimation unit 212, the display control unit 214, the flexible display 220, the bending measurement unit 230, the fixing panel 240, the position measurement unit 250, and the storage unit 260 may be performed by the control unit 210. Further, the apparatus 200 may include more units to provide other functions, may combine certain units into a single unit, or may not include some of the above mentioned units.

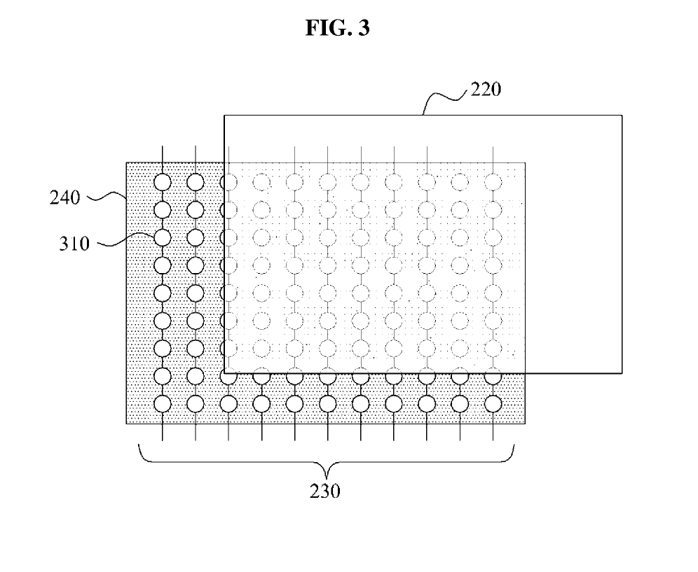

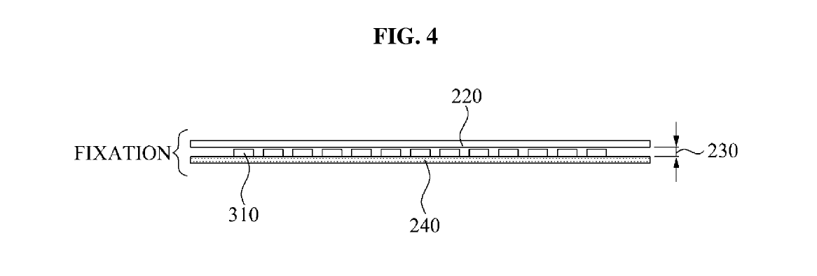

FIG. 3 is a diagram illustrating a combination of a flexible display, a bending measurement unit, and a fixing panel according to an exemplary embodiment of the present invention. FIG. 4 is a sectional diagram illustrating the combination of a flexible display, a bending measurement unit, and a fixing panel according to an exemplary embodiment of the present invention.

Referring to FIG. 3 and FIG. 4, the bending measurement unit 230 having multiple arranged sensors 310 is positioned and fixed between the flexible display 220 and the fixing panel 240.

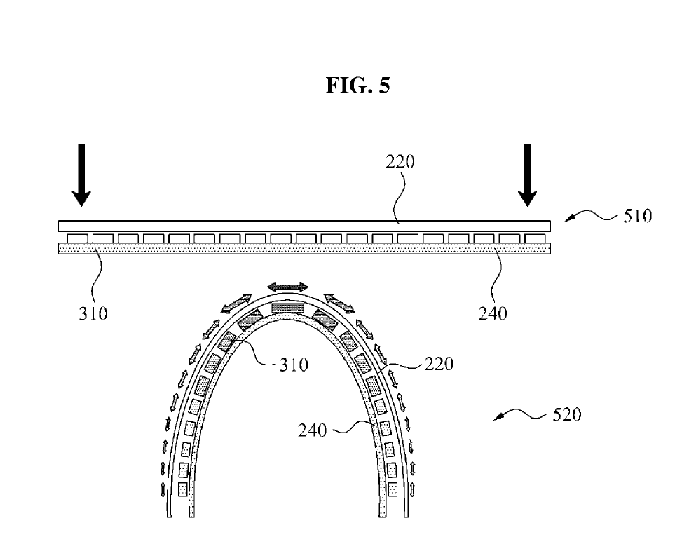

FIG. 5 is a diagram illustrating the arrangement of sensors included in the bending measurement unit when a flexible display is bent according to an exemplary embodiment of the present invention.

Referring to FIG. 5, as the flexible display 220 is bent, a physical force is applied to each of the multiple sensors 310 of the bending measurement unit 230 attached to the back of the flexible display 220. Each of the multiple sensors 310 measures a force applied to a position at which each of the multiple sensors 310 is attached to the flexible display 220 or measures a degree of bending at a position at which each of the multiple sensors 310 is attached to the flexible display 220. In FIG. 5, each of the multiple sensors 310 is indicated darker as the applied force to the sensor increases.

The position measurement unit 250 identifies the position of a viewer (also referred to as a user) that views the flexible display 220. The position of the viewer may be identified by capturing a front view of the flexible display 220 or the position of the viewer using an image capturing device such as a camera. The position of the viewer may be determined based on the degrees of bending measured by each of the multiple sensors 310. The position of the viewer may be determined by determining a virtual plane and identifying the perpendicular direction of the virtual plane of the flexible display 220. The virtual plane may be one projection view of the flexible display 220 when the flexible display 200 is bent, which has the largest area among all possible projection views. Further, the position measurement unit 250 may determine a viewing direction of a viewer as a determined direction. The determined direction may be determined based on the bending values, the bent shape, or both of the flexible display 220. In an example, the determined direction may be determined as a direction that maximizes the area of the virtual planar display.

The storage unit 260 stores an operating system for controlling the entire operation of the apparatus 200, an application program, and data such as compressed image files, and moving pictures. The storage unit 260 may be embodied in whole or in part as memory dedicated to a central processing unit, which may perform the functions of the control unit 210.

The storage unit 260 may store a correction table for correcting a distorted image into a planar image.

The correction table is a table that stores a correction value to correct an image to a planar image of a virtual planar display which is perpendicular to a determined direction. In this instance, the determined direction may be a perpendicular direction of the flexible display if the flexible display 220 is in planar state. The correction table may be a table that stores a correction value corresponding to an image distortion generated when the flexible display 220 is bent and viewed at a determined direction as the viewing position of the viewer.

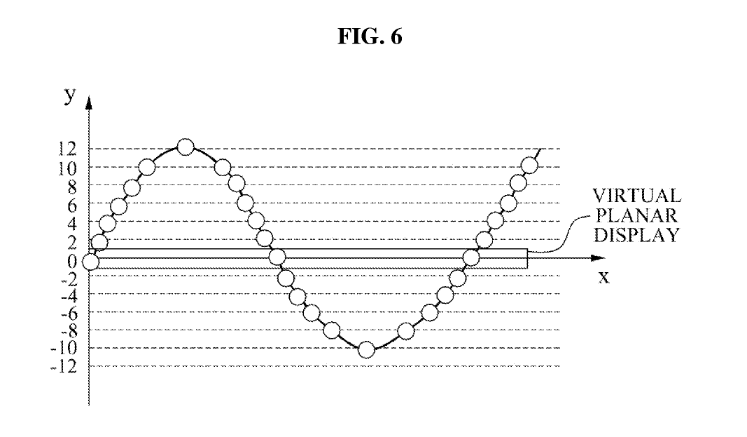

The shape estimation unit 212 estimates the bent shape of the flexible display 220 using a bending value. The shape estimation unit 212 may estimate the bent shape as shown in FIG. 6.

FIG. 6 is a diagram illustrating an estimated bent shape according to an exemplary embodiment of the present invention.

Referring to FIG. 6, an X-axis shows an order of the multiple sensors 310 connected to one another in a vertical or horizontal direction, and a Y-axis shows heights of the multiple sensors 310, in which the bent shape is visualized using measurement values of the multiple sensors 310. The ‘0’ value of the Y-axis means a reference height when the flexible display 220 is in a planar state.

If the flexible display 220 is viewed from the determined direction, the display control unit 214 corrects an image distortion generated by the bent shape of the flexible display 220 to be viewed as a planar image from the determined direction and displays the corrected image through the flexible display 220. In this instance, the display control unit 214 retrieves a correction value corresponding to the image distortion and corrects the image distortion into the corrected image by using the correction value.

If the flexible display 220 is viewed from the viewing position of the viewer, the display control unit 214 corrects an image distortion generated by the bent shape of the flexible display 220 to be viewed as a planar image and displays the corrected image through the flexible display 220. In this instance, the display control unit 214 retrieves a correction value corresponding to the image distortion and corrects the image distortion into the corrected image by using the correction value.

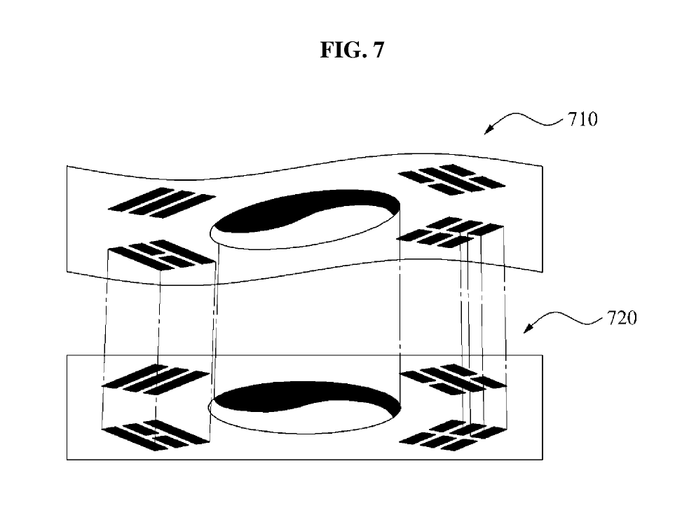

For example, the display control unit 214 may correct a distorted image of the national flag of Korea into a planar image of the national flag of Korea as shown in FIG. 7.

FIG. 7 is a diagram illustrating correcting a distorted image into a planar image when a flexible display is bent according to an exemplary embodiment of the present invention.

Referring to FIG. 7, the display control unit 214 corrects a distorted image 710 of the national flag of Korea, displayed through the bent flexible display 220, into a planar image of the national flag of Korea by using the correction table.

In addition, the display control unit 214 may correct a distorted image into a planar image so that the aspect ratio of the distorted image is proportional to that of the corrected image. Alternatively, the display control unit 214 may correct a distorted image into a planar image so that the size of the corrected image corresponds to a projected perimeter of the bent flexible display 220, even though the aspect ratio of the corrected image may not be proportional to the aspect ratio of the distorted image in this display scheme. As used herein, the projected perimeter is a perimeter of the flexible display projected onto the virtual planar display, such as shown in FIG. 1B.

The control unit 210 may control the operation of the apparatus 200. The control unit 210 may perform the functions of the shape estimation unit 212 and the display control unit 214. The control unit 210, the shape estimation unit 212 and the display control unit 214 are separately described so as to describe their distinct functions. Thus, in a case where an apparatus is practically implemented, the control unit 210 may be implemented to perform the functions of the shape estimation unit 212 and the display control unit 214. Alternatively, the control unit 210 may be implemented to perform a portion of the functions of the shape estimation unit 212 and the display control unit 214, or a single unit other than the control unit 210 may perform the functions of both the shape estimation unit 212 and the display control unit 214.

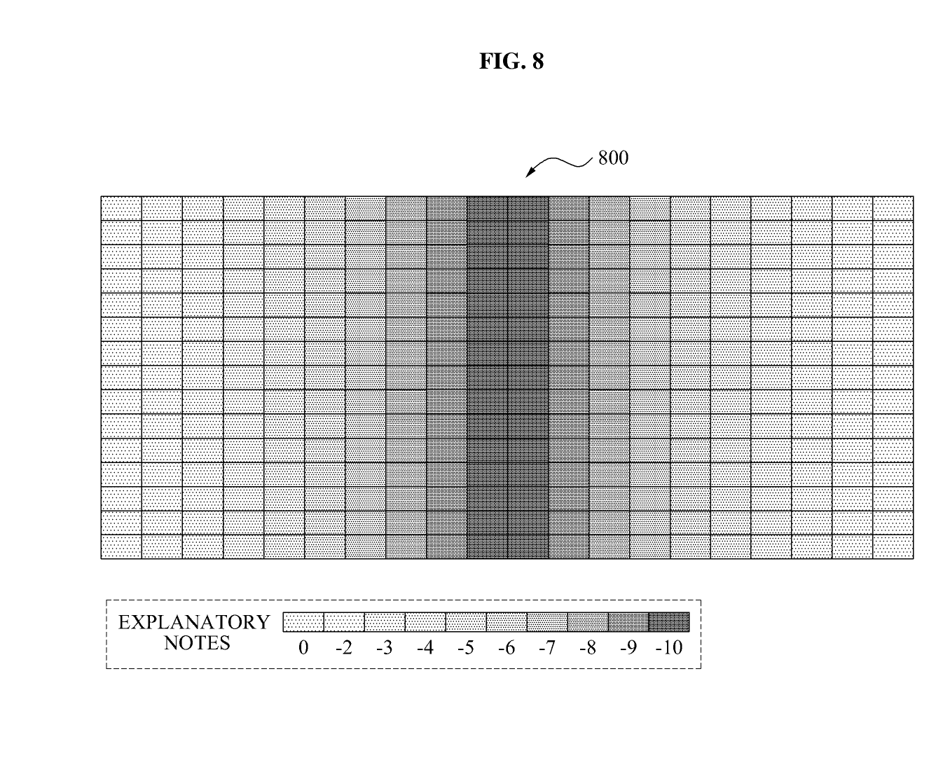

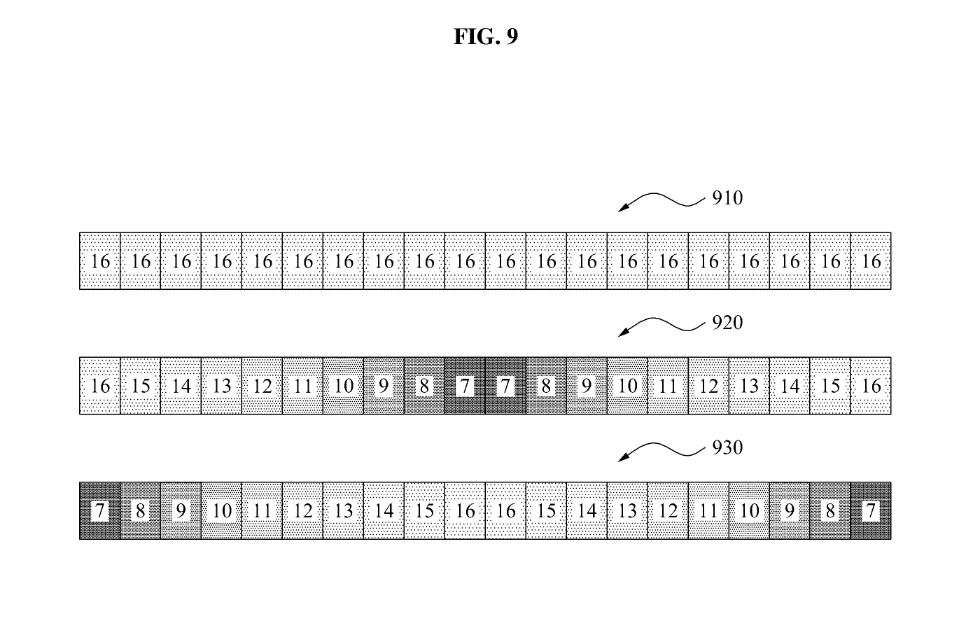

If the size of the flexible display 220 is Quarter Video Graphics Array (QVGA) in the apparatus 200, the process of detecting and correcting a bent shape of the flexible display 220 will be described with reference to FIG. 8 and FIG. 9.

The flexible display 220 having a size of QVGA may be configured as 320*240 pixels.

In a case where 16*16 pixels are configured as a measurement block for measuring the bending of the flexible display 220, measurement blocks may be arranged to be 20 columns and 15 rows in the flexible display 220 having a size of QVGA. If the flexible display 220 is bent by applying a force to the left and right of the flexible display 220, the bending of the flexible display 220 may be illustrated as shown in FIG. 8.

FIG. 8 is a diagram illustrating the bending degree of a flexible display using shading according to an exemplary embodiment of the present invention.

Referring to FIG. 8, a center of the flexible display 220 is concavely bent downward such that the center of the flexible display 220 has the greatest degree of rotation, shown as a measurement value 800 of the flexible display 220. The left and right edges of the flexible display 220 have a more neutral degree of rotation, such that the measurement value 800 is closer to zero, which is the measurement value when the flexible display (or portion thereof) is planar. A physical arrangement of the flexible display 220 shown in FIG. 8 would be similar to an arch, with the center of the flexible display 220 at the peak of the arch. As the shading of a measurement block gets darker, the bending degree of the measurement block increases.

The correction process of the display control unit 214 will be described with reference to FIG. 9.

FIG. 9 is a diagram illustrating a correcting method when a flexible display is bent according to an exemplary embodiment of the present invention.

Referring to FIG. 9, a planar state 910 is one row of the QVGA flexible display 220 in a planar state. In the planar state 910, the width of each measurement block is 16 and is identical to the number of pixels configured for the width of each measurement block as described above.

A distortion state 920 is one row of the flexible display 220 being concavely bent downward like one row of the measurement value 800 of the flexible display 220 in FIG. 8. In the distortion state 920, the width of each measurement block of the flexible display 220 that is concavely bent has a smaller value than the width of each measurement block that is not bent, as indicated by the values shown in each of the measurement blocks.

A correction state 930 refers to a value being corrected so that an image distorted by the distortion state 920 is viewed as a planar image. In the correction state 930, the width of each measurement block is controlled so that the distorted image in the distortion state 920 is corrected into a planar image.

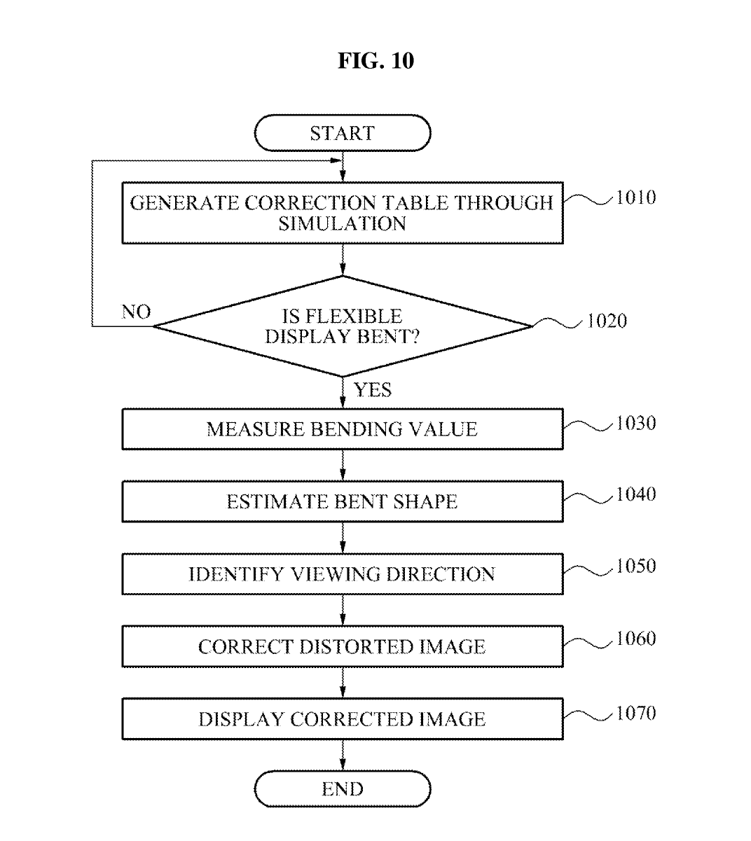

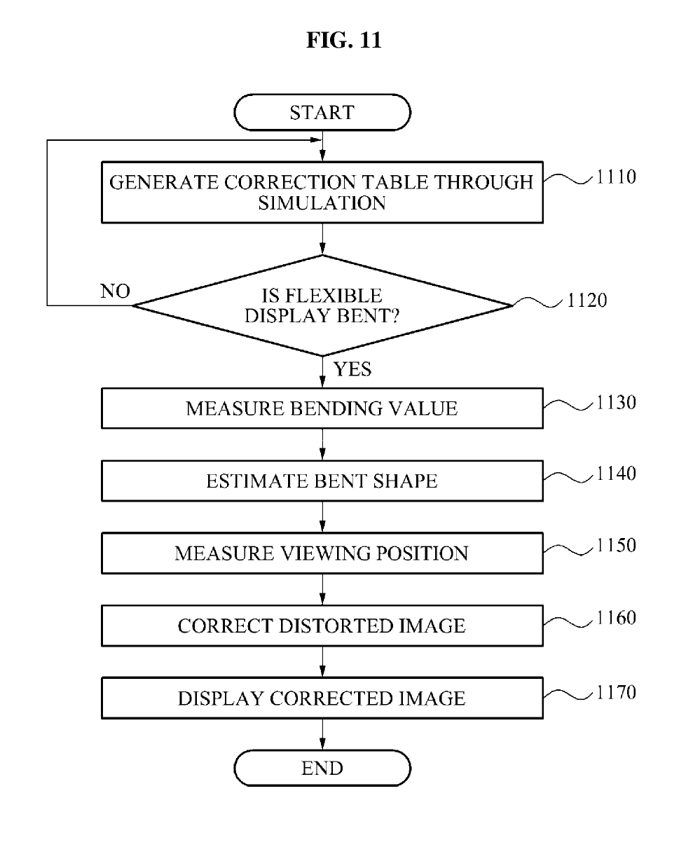

Hereinafter, a method for displaying a corrected image in a bent flexible display of an apparatus will be described with reference to FIG. 10 and FIG. 11.

FIG. 10 is a flowchart illustrating a method for displaying a corrected image using an apparatus equipped with a flexible display according to an exemplary embodiment of the present invention. FIG. 10 will be described such that the apparatus 200 is performing the method. However, the method is not limited thereto.

Referring to FIG. 10, in operation 1010, the apparatus 200 generates a correction table through simulation before an image is displayed through the flexible display 220. In this instance, the correction table is a table that stores a correction value corresponding to an image distortion generated when a bent flexible display 220 is viewed from a determined viewing direction.

If the apparatus 200 senses the occurrence of bending of the flexible display 220 in operation 1020, the apparatus 200 measures bending values that show degrees of bending in the flexible display 220 through the multiple sensors 310 attached to the flexible display 220 in operation 1030.

In operation 1040, the apparatus 200 estimates a bent shape of the flexible display 220 using the bending values.

In operation 1050, the apparatus 200 identifies a viewing direction or a determined direction. In this instance, the viewing direction may be a perpendicular direction to a virtual planar display of the flexible display 220. The viewing direction may be determined as described above in more detail.

Based on determined viewing direction, the apparatus 200 corrects a distorted image generated by the bent shape of the flexible display 220 to be viewed as a planar image in operation 1060.

In operation 1070, the apparatus 200 displays the corrected image.

FIG. 11 is a flowchart illustrating a method for displaying a corrected image using an apparatus equipped with a flexible display according to an exemplary embodiment of the present invention. FIG. 11 will be described such that the apparatus 200 is performing the method. However, the method is not limited thereto.

Referring to FIG. 11, in operation 1110, the apparatus 200 generates a correction table through simulation before displaying an image through the flexible display 220. The correction table is a table that stores a correction value corresponding to an image distortion generated when the bent flexible display 220 is viewed in a viewing direction.

If the apparatus 200 senses the occurrence of bending of the flexible display 220 in operation 1120, the apparatus 200 measures bending values that show degrees of bending of the flexible display 220 using the multiple sensors 310 attached to the flexible display 220 in operation 1130.

In operation 1140, the apparatus 200 estimates a bent shape of the flexible display 220 by using the bending values.

In operation 1150, the apparatus 200 measures the viewing position of a viewer.

Based on the viewing position of the viewer, the apparatus 200 corrects a distorted image generated by the bent shape to be viewed as a planar image in operation 1160.

In operation 1170, the apparatus 200 displays the corrected image.

The image correction method described above may be applied to an apparatus equipped with a flexible display.

The apparatus may be a wristwatch or a bracelet having the flexible display. In this case, the apparatus may provide a planar image without distortion even if the wristwatch or bracelet is bent due to design characteristics.

The apparatus may be clothes such as a T-shirt having the flexible display. In this case, the apparatus may provide a planar image without distortion by correcting the distortion generated by wrinkles of the clothes or the body shape of a wearer.

The methods according to the exemplary embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the present invention.

According to exemplary embodiments of the present invention, a viewer of a flexible display may view a planar image in an apparatus equipped with a flexible display regardless of the curved state of the flexible display. The planar image may be displayed by measuring a degree of bending of the flexible display and reflecting a measured value to an image output. Thus, it is possible to provide a planar display image regardless of bending of the flexible display.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
a flexible display;
a shape estimation unit to estimate a bent shape of the flexible display; and
a display control unit to correct an image based on the bent shape and to control the flexible display to display a corrected image.

2. The apparatus of claim 1, further comprising:
a bending measurement sensor to measure a bending value of a portion of the flexible display; and
a correction table to store a correction value based on the bent shape and a viewing direction of a viewer,
wherein the shape estimation unit estimates the bent shape of the flexible display based on the bending value and the display control unit corrects the image using the correction value.

3. The apparatus of claim 1, further comprising a position measurement unit to measure a viewing direction of a viewer,
wherein the display control unit corrects the image to be viewed as a planar image of a virtual planar display arranged perpendicular to the viewing direction.

4. The apparatus of claim 3, further comprising a correction table to store a correction value based on the bent shape and the viewing direction of a viewer,
wherein the display control unit corrects the image using the correction value.

5. The apparatus of claim 2, wherein the bending measurement sensor is fixed to one side of the flexible display.

6. The apparatus of claim 1, further comprising bending measurement sensors arranged at an interval in horizontal and vertical directions of the flexible display.

7. The apparatus of claim 2, wherein the bending measurement sensor comprises a load cell to change a physical force into an electrical signal, or a bend sensor having a property that increases resistance according to the bending angle of the bend sensor.

8. The apparatus of claim 1, wherein an aspect ratio of the image is proportional to an aspect ratio of the corrected image.

9. The apparatus of claim 1, wherein a size of the corrected image corresponds to a size of a projected perimeter of the flexible display.

10. The apparatus of claim 1, further comprising a fixing panel and bending measurement sensors,
wherein the bending measurement sensors are positioned between the flexible display and the fixing panel.

11. A method for displaying a corrected image, comprising:
measuring a bending value of a portion of a flexible display;
estimating a bent shape of the flexible display using the bending value;
correcting an image based on the bent shape to be viewed as a planar image of a virtual planar display arranged perpendicular to a viewing direction; and
displaying the corrected image on the flexible display.

12. The method of claim 11, further comprising:
generating a correction table to store a correction value to correct the image into the planar image of the virtual planar display based on the viewing direction and the bent shape; and
retrieving the correction value from the correction table,
wherein correcting the image comprises correcting the image using the correction value.

13. The method of claim 11, further comprising:
measuring a viewing direction of a viewer,
wherein the viewing direction is determined to maximize an area of the virtual planar display or the viewing direction is determined by capturing a position of the viewer.

14. The method of claim 13, further comprising:
generating a correction table to store a correction value to correct the image into the planar image of the virtual planar display based on the viewing direction and the bent shape; and
retrieving the correction value from the correction table,
wherein correcting the image comprises correcting the image into the corrected image using the correction value.

15. The method of claim 11, wherein the bending value is measured by a sensor, the sensor being a load cell that changes a physical force into an electrical signal, or a bend sensor having a property that increases resistance according to the bending angle of the bend sensor.

16. The method of claim 11, wherein measuring the bending value comprises measuring the bending value using sensors arranged at intervals in horizontal and vertical directions of the flexible display.

17. The method of claim 11, wherein an aspect ratio of the image is proportional to an aspect ratio of the corrected image.

18. The method of claim 11, wherein a size of the corrected image corresponds to a size of a projected perimeter of the flexible display.

19. An apparatus, comprising:
a flexible display;
a position measurement unit to measure a viewing direction of a viewer;
a shape estimation unit to estimate a bent shape of the flexible display; and
a display control unit to correct an image based on the bent shape and to control the flexible display to display a corrected image,
wherein the display control unit determines a virtual planar display based on the viewing direction of the viewer and the bent shape of the flexible display, determines a projection view of the image of the flexible display projected to the virtual planar display, corrects the image as according to the projection view, and controls the flexible display to display the corrected image.

20. The apparatus of claim 19, further comprising:
a bending measurement sensor to measure a bending value of a portion of the flexible display,
wherein the bending value is measured according to a magnitude of a force sensed by the sensor, and the display control unit corrects the image by adjusting a width of a measurement block corresponding to the sensor according to the bending value.
